(19) United States
(12) Patent Application Publication
(10) Pub. No.: US 2018/0108231 A1
(43) Pub. Date: Apr. 19, 2018

(54) WIRELESS SECURITY SYSTEM

(71) Applicant: Se-Kure Controls, Inc., Franklin Park, IL (US)

(72) Inventors: Roger J. Leyden, Inverness, IL (US); David M. Adams, Stone Park, IL (US)

(21) Appl. No.: 15/845,581

(22) Filed: Dec. 18, 2017

Related U.S. Application Data
(63) Continuation-in-part of application No. 15/426,509, filed on Feb. 7, 2017.
(60) Provisional application No. 62/294,610, filed on Feb. 12, 2016.

(51) Int. Cl. G08B 13/24; G08B 25/10

(52) U.S. Cl. CPC G08B 13/2402; G08B 25/10

(57) ABSTRACT

A wireless system for monitoring portable articles includes a base unit comprising a programmed controller operatively associated with a base wireless communication circuit and a base alarm indicator circuit. At least one wireless sensor comprises a housing enclosing a programmed controller operatively associated with a sensor wireless communication circuit, for communicating with the base wireless communication circuit. A security assembly is configured to: maintain the housing in an operative state on a portable article being monitored; and generate an alert signal if the security assembly is altered with the housing in the operative state in a manner that allows separation of the housing from a portable article being monitored. The base unit is programmed to activate the base alarm indicator circuit if the at least one wireless sensor generates an alert signal or if the base unit senses a communication error with the at least one wireless sensor.

### BACKGROUND OF THE INVENTION

### Field of the Invention

This invention relates to security systems for portable articles and, more particularly, to wireless sensors that can be secured to a portable article.

### Background Art

It is known to provide security systems using sensors on portable articles that continuously generate signals that can be monitored to track the location of the articles, as within a business in which the articles are displayed. One such category of sensor is identified commonly as a “beacon”. These systems can be designed so that a detectable alarm is generated if the article with the associated system is moved outside of a certain predetermined area.

These systems are commonly associated with articles such that would-be thieves might be able to separate the system from the article and thereby abscond with the article without detection. For example, the system might be placed loosely within a purse or another type of monitored article that has a suitable receptacle. Alternatively, the system might be secured inside or outside of an article through a mechanical-type connection, such as a mechanical clasp, or an adhesive, that might be defeated to separate the system from the article without detection.

With an increasing number of expensive, portable articles being displayed, and accessible to be handled by potential purchasers, the need for better, affordable and reliable security systems remains pressing.

### SUMMARY OF THE INVENTION

In one form, the invention is directed to a wireless system for monitoring a portable article. The system includes a base unit comprising a programmed controller operatively associated with a base wireless communication circuit and a base alarm indicator circuit. At least one wireless sensor comprises a housing enclosing a programmed controller operatively associated with a sensor wireless communication circuit, for communicating with the base wireless communication circuit. A security assembly is configured to: maintain the housing in an operative state on a portable article being monitored; and generate an alert signal in the event that the security assembly is altered with the housing in the operative state in a manner that allows separation of the housing from a portable article being monitored. The base unit is programmed to activate the base alarm indicator circuit if the at least one wireless sensor generates an alert signal or if the base unit senses a communication error with the at least one wireless sensor.

It is a feature that the securing assembly comprises a tether that in conjunction with the housing extends fully around a part of a portable article being monitored with the housing in its operative state.

It is another feature that the securing assembly comprises a tether that extends fully around a part of an article being monitored with the housing in its operative state.

It is another feature that the securing assembly comprises a tether that defines at least part of an electrical circuit path and the securing assembly is configured to generate the alert signal in the event that the electrical circuit path is interrupted.

It is still another feature that the base unit senses a communication error in the event that the housing is moved outside of a predetermined area.

It is still another feature that the base unit senses a communication error in the event that communication is lost with the at least one wireless sensor.

It is a further feature that the at least one wireless sensor comprises a sensor alarm indicator circuit and the at least one wireless sensor is programmed to activate the sensor alarm indicator circuit if the at least one wireless sensor generates an alert signal or if the base unit senses a communication error with the at least one wireless sensor.

It is still a further feature that the base unit comprises a Bluetooth Smart module comprising the programmed controller and the base wireless communication circuit.

It is yet another feature that the wireless sensor comprises a Bluetooth Smart module comprising the programmed controller and the sensor wireless communication circuit.

It is still another feature that the base wireless communication circuit periodically polls the sensor wireless communication circuit and the sensor wireless communication circuit responds with data representing an identification parameter and status of the alert signal.

It is still a further feature that each of the base unit and the at least one wireless sensor comprises a calibrate button used to link the base wireless communication circuit with the sensor wireless communication circuit.

There is disclosed in accordance with another aspect a wireless security system for monitoring portable articles comprising a base unit comprising a programmed controller operatively associated with a base wireless communication circuit and a base alarm indicator circuit. A plurality of wireless sensors are provided. Each wireless sensor comprises a housing enclosing a programmed controller operatively associated with a sensor wireless communication circuit, for communicating with the base wireless communication circuit, and a securing assembly. The securing assembly is configured to maintain the housing in an operative state on a portable article being monitored; and to generate an alert signal in the event that the securing assembly is altered with the housing in the operative state in a manner that allows separation of the housing from a portable article being monitored. The base unit is programmed to activate the base alarm indicator circuit if any of the plurality of wireless sensors generates an alert signal or if the base unit senses a communication error with any of the plurality of wireless sensors.

Further features and advantages of the invention will be readily apparent from the specification and from the drawings.

### BRIEF DESCRIPTION OF THE DRAWINGS

FIG. 1 is a block diagram of a wireless security system for monitoring portable articles, according to the invention;

FIG. 2 is a block diagram of the wireless alarm base of FIG. 1;

FIG. 3 is a block diagram of an electrical schematic for the wireless alarm beacons of FIG. 1;

FIG. 4 is a flow diagram illustrating an algorithm implemented by the base of FIG. 2;

FIG. 5 is a flow diagram of an algorithm implemented by the beacons of FIG. 3;

FIG. 6 is a state diagram for the base of FIG. 2;

FIG. 7 is a state diagram for the beacon of FIG. 3; and

FIGS. 8-10 illustrate alarm scenarios with the wireless security system of FIG. 1.

### DETAILED DESCRIPTION OF THE PREFERRED EMBODIMENT

A wireless security system disclosed herein uses a base that can communicate with up to eight wireless sensors. Each sensor is tethered or otherwise affixed to the portable article it is protecting by, for example, a wire, or the like, and includes a beacon which is a Bluetooth proximity beacon. The beacon advertises ID data that is compatible with common beacon standards (UUID, major ID, and minor ID). The sensor periodically broadcasts its ID to the base and broadcasts its ID with an alarm code if an error condition is found, such as the wire being cut. The base receives the alert signal if the wire is cut and can use the periodic broadcast from the sensor to determine if the sensor is out of range. These can be used to generate an alarm.

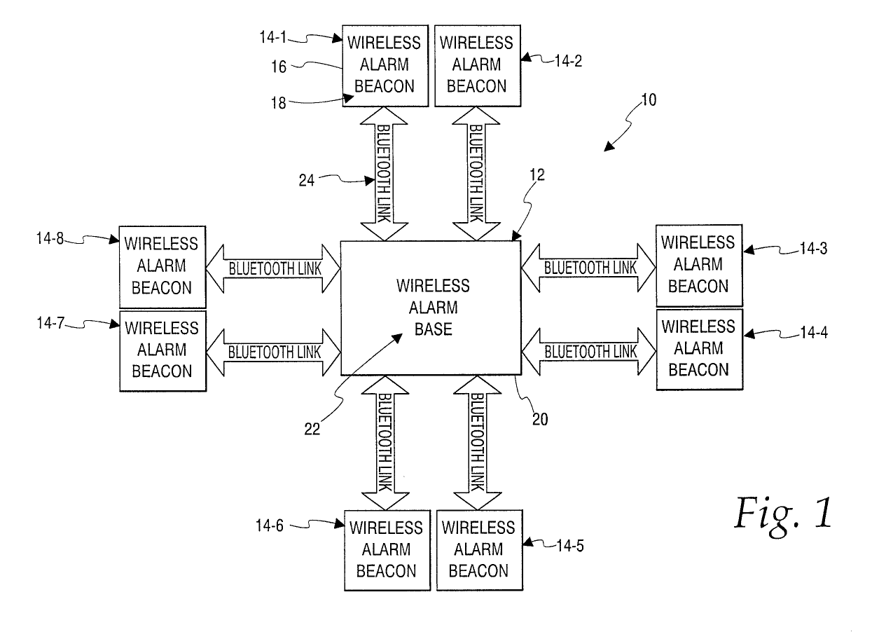

Referring to FIG. 1, a wireless security system 10 for monitoring portable articles is illustrated in block diagram form. The system 10 comprises a base unit 12 and up to eight sensors 14-1 through 14-8. Each of these sensors is identical in construction except for having a unique ID and optionally having a particular securing assembly, as described below. For simplicity, the sensors are referenced generically with the numeral 14.

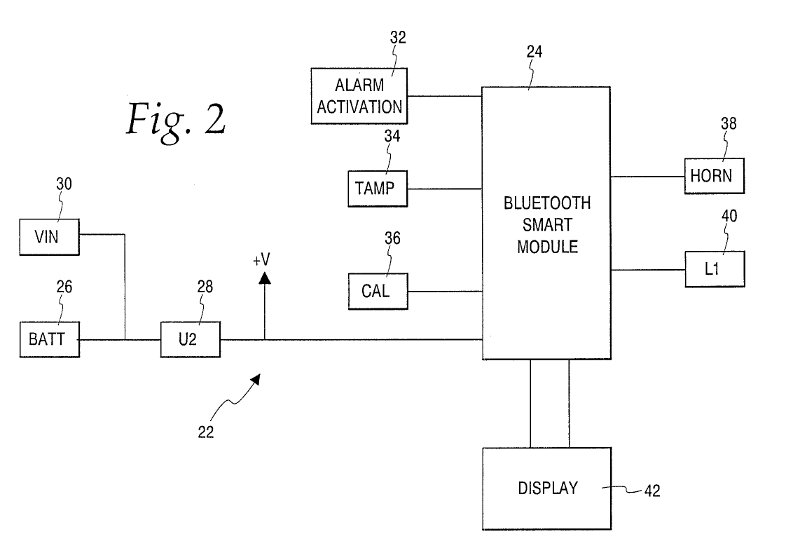

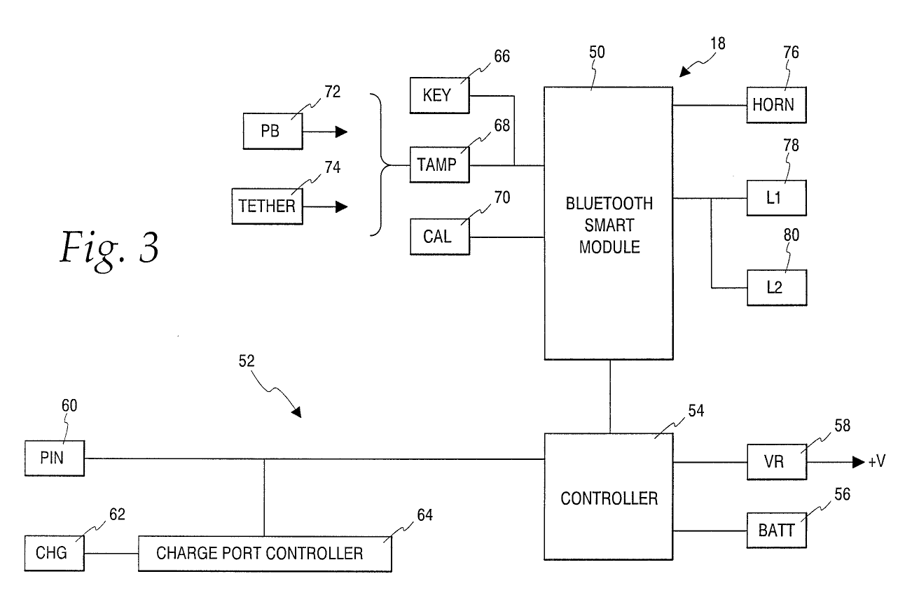

Each sensor 14 comprises a housing, represented by the block 16, housing an alarm beacon 18 discussed in greater detail in connection with FIG. 3. The base unit 12 comprises a housing, represented by the block 20, housing a wireless alarm base 22, described below relative to FIG. 2. The base unit 12 communicates with each sensor 14 via a wireless Bluetooth link 24. Other forms of wireless communication could be used.

Referring to FIG. 2, a block diagram illustrates a circuit for the alarm base 22. The base 22 includes a Bluetooth Smart module 24. The module 24 may be, for example, a BGM111 Bluetooth Smart nodule for Bluetooth low energy applications. The module 24 comprises a programmed controller having a processor and memory and a Bluetooth low energy radio providing a sensor wireless communication circuit, as is known. The module 24 includes a Bluetooth radio, a software stack that can host end user applications and has interfaces to connect to peripherals or sensors. It can be operated using a battery 26. The battery 26 is connected to a block 28, labeled U2, comprising a step-down-DC converter. The converter 28 may also be connected to a Vin block 30 to be connected to a DC supply. The converter 28 generates an output voltage +V for driving the base 22 and powering the module 24.

The module 24 is connected to an alarm activation circuit 32 which is operable in any known manner to set the mode of operation of the base unit 12, as described below. The module 24 is also connected to a tamper circuit 34 and a calibrate circuit 36. The housing 12 may be mounted on a countertop, or the like. The tamper circuit 34 may comprise a push button on the bottom of the unit, or a foot, or the like, which senses if the housing 20 is picked up off the countertop. The calibrate circuit 36 comprises a push button used to initiate communication with sensors 14, as described below.

The module 24 is connected to several output devices, including a horn circuit 38, an L1 indicator 40 and a display module 42. The horn circuit 38 is used to generate an audible signal if an alarm condition is found. The indicator 40, which may be an LED, likewise can be used to indicate the presence of an alarm condition or act as a power indicator. The display module 42 comprises an LED matrix including one LED for each sensor 14, for a total of eight in the illustrative embodiment. The individual LEDs indicate which of the respective sensors 14 has generated an alert signal or if the base unit 12 senses a communication error.

Referring to FIG. 3, a block diagram for the circuitry of the beacon 18 is illustrated and comprises a Bluetooth Smart module 50. The module 50 may also be a BGM111 Bluetooth Smart module, as with the base unit module 24. The beacon 18 includes a power circuit 52 having a controller 54 comprising a battery charge management controller. The controller 54 may be, for example, an MCP73871circuit device. The controller 54 is powered by a battery 56. The controller 54 is connected to a voltage regulator 58 which provides power to the remaining circuitry via +V. The controller 54 is coupled to a pin 60 which allows the sensor 14 to be optionally connected to the base unit 12 for charging of the battery 56. Alternatively, a charge input 62 may comprise, for example, a USB connector for connecting to a power source via a USB cable. The charge connector 62 is coupled via a charge port controller 64 to the pin 60. The charge port controller 64 may be a TPS2511DGM circuit.

The module 50 is connected to various input circuits including an auxiliary input circuit 66, a tamper circuit 68 and a calibrate circuit 70. The tamper circuit 68 may be of many different constructions. For example, the tamper circuit 68 may comprise a push button 72 which is activated when the housing 16 is secured to the portable article. If the housing 16 is separated from the article, then the push button is released, as is known. Alternatively, the tamper circuit 68 may utilize a tether 74. The tether may be of the form illustrated in our co-pending application No. 15/426,509, the specification of which is incorporated herein. The tether 74 may be a flexible cord with a connector at one end that can be releasably joined to the housing 16 to complete an electrical circuit path. The tether 74 could alternatively have a fixed shape, the tether could have a free end that can be directed through an opening in an article to be monitored or a fully surrounded capture and arrangement can be formed for the tether being wrapped continuously around the portable article. Other forms of tampering circuit 68 may also be used.

To locally indicate an alarm condition at the sensor 14, the module 50 is connected to a horn circuit 76 and first and second light indicators 78 and 80. While the indicators 78 and 80 are shown connected to a single output, they may be connected to dual outputs to indicate dual alert conditions, as necessary or desired.

As described more fully below, the base unit 12 has operating modes set by the alarm activation circuit 32. These include an unarmed mode and an armed mode.

A calibration mode is used any time it is necessary to pair a wireless sensor 14 with the base unit 12. To activate the calibration mode, the base 22 must be in standby which happens when the alarm activation circuit 32 is placed in the unarmed mode. While in standby, pressing and holding the calibration button 36 for a set period, such as 10 seconds, will cause the module 24 to enter calibration mode. All of the LEDs in the display 42 will flash. Once the base 22 is in the calibration mode, then the operator will press the calibrate button 70 on one of the beacons 18 which will transmit its sensor Bluetooth Smart module user ID to the base 22. The base 22 will then send back to the beacon 18 the base Bluetooth Smart module user ID and an acknowledgment. The base 22 will store this ID for reference, illuminate the associated LED in the display 42 and then wait for the next sensor user ID. Once all eight beacons 18 are programmed, then a second press of the calibration button 36 will take the base 22 out of calibration. Thereafter, all the LEDs in the display 42 will illuminate in a rotational fashion once every 25 seconds to preserve battery power. The LEDs may stay illuminated if external power is applied.

Once the operator presses the calibration button 70 on the beacon 18, the beacon 18 will transmit the user ID, as discussed above. Once it receives the base user ID and acknowledgment, the beacon 18 will store the base user ID in memory for reference and then the beacon 18 will go into standby mode waiting for commands from the base 22.

Both the base unit Smart module 24 and the sensor Smart module 50 contain a firmware package based on the Silicon Labs Bluetooth Smart Software protocol stack. In each case, operation takes place in a main execution loop.

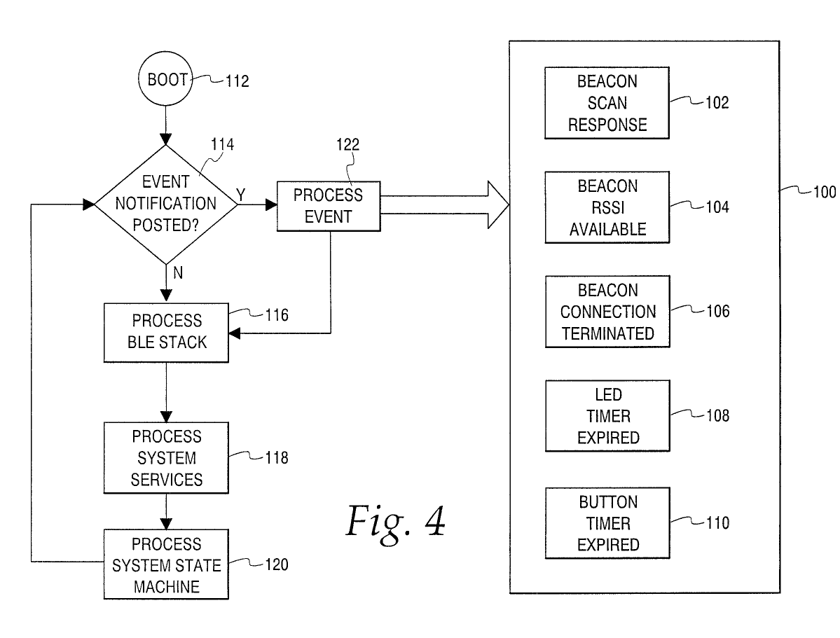

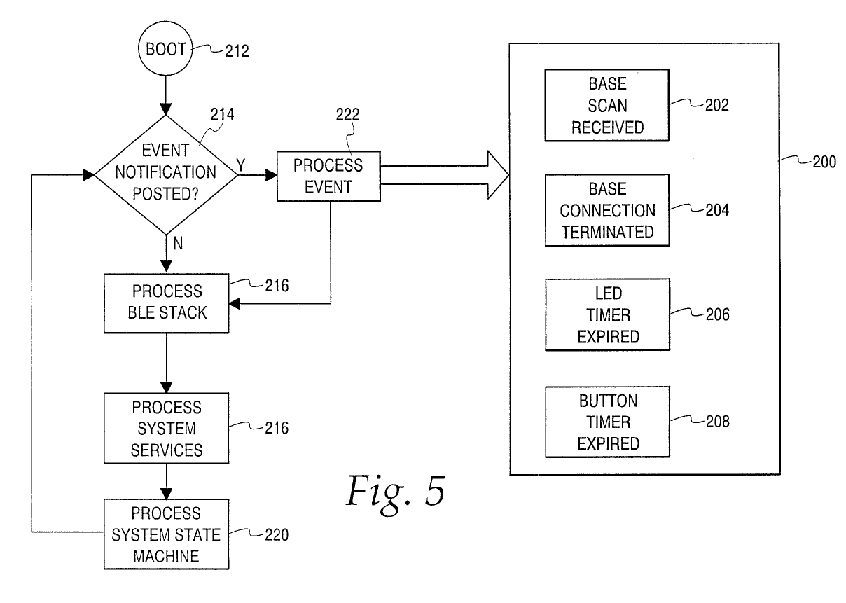

Referring to FIG. 4, a flow diagram illustrates the main loop implemented in the base Smart module 24. FIG. 5 illustrates the main loop implemented in the sensor Smart module 50. During iterations of the main loop, the Bluetooth low energy (BLE) and system service blocks may post event notifications to the events notification que. When this happens, the events are processed one by one at the start of the next loop iteration. The base unit Smart module 24 includes an event notification list 100, see FIG. 4, while the sensor Smart module 50 includes an event notification list 200, see FIG. 5.

The base event notification list 100 includes the following events: beacon scan response 102; beacon RSSI available 104; beacon connection terminated 106; LED timer expired 108; and button timer expired 110. The beacon scan response 102 is a notification from the BLE stack that a beacon 18 has responded to the base unit discovery scan. Each time this event occurs, the base 22 will attempt to establish a Bluetooth connection with the responding beacon 18. The beacon RSSI available 104 has an updated RSSI (received signal strength indicator) associated with one of the beacons 18. The beacon connection terminated notification 106 occurs when the BLE stack has lost a connection with one of the beacons 18. The LED timer expired notification 108 is a notification that the system LED indicator update interval has ended and it is time for the base to update the system LED indicators. The button timer expired notification 110 indicates that the push button input poll timer has expired and it is time for the base 22 to poll its user input buttons and update relevant system variables.

The sensor event notification list 200 includes the following events: base scan received 202; base connection terminated 204; LED timer expired 206; and button timer expired 208. The base scan received notification 202 is a BLE stack notification that indicates that a base scan signal has been received and that the beacon should respond that it is available for connection. The base connection terminated notification 204 is a notification in a beacon that the BLE stack has lost a connection with the base 22. The LED timer expired notification 206 is a notification that the system LED indicator update interval has ended and it is time for the beacon 18 to update the system LED indicators. The button timer expired notification 208 indicates that the push button input poll timer has expired and it is time for the beacon 18 to poll its user input push buttons and update relevant system variables.

Referring to FIG. 4, the base flow diagram begins at a boot node 112 at power up. This initializes hardware, Bluetooth stack and a system state machine and initiates Bluetooth advertisement packets. A decision block 114 determines whether or not an event notification has been posted. If not, then the BLE stack is processed at a block 116 to manage the software stack. A block 118 processes system services, such as managing timers, interrupts, and the like. A block 120 processes the system state machine, described below. The process then loops back to the decision block 114. If an event notification has been posted, as discussed above, then the event from the list 100 is processed at a block 122 and then the program proceeds to the block 116 and continues as above.

Referring to FIG. 5, the main loop flow chart for the beacon 18 is illustrated. This flow chart is similar to that of FIG. 4, with numbers in the 200 series. As such, respective blocks 212, 214, 216, 218, 220 and 222 correspond to blocks 112, 114, 116, 118, 120 and 122 of FIG. 4 and are not otherwise discussed in detail herein.

In both the base 22 and beacons 18 alarm management is implemented via a system state machine which is serviced during main loop iteration in the respective blocks 120 and 220, above. The state machine is responsible for handling user inputs and alarm conditions based on a set of system state variables. These are updated based on a variety of factors which include the current state of the device.

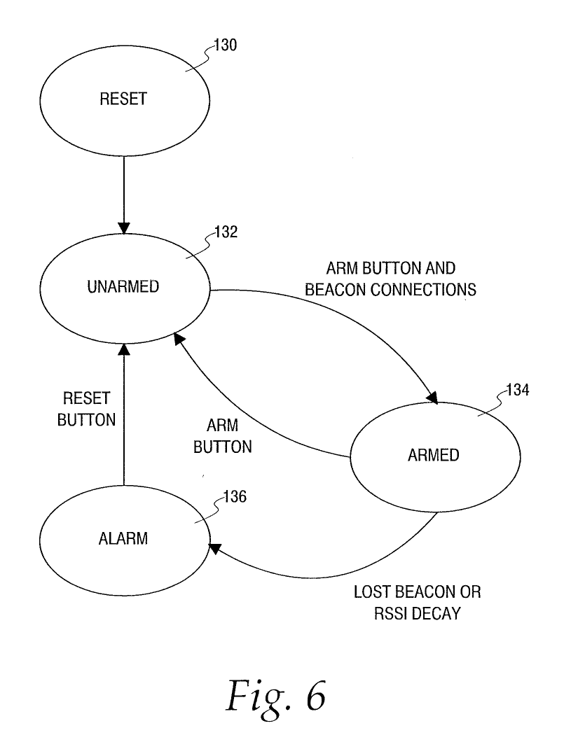

FIG. 6 illustrates the state diagram for the base 22. The states include a reset state 130, an unarmed state 132, an armed state 134 and an alarm state 136. The reset state 130 is the default power-up state for the base 22. In this state system variables, hardware, and the BLE stack are initialized and the main loop is started. The system state always transitions automatically to the unarmed state 132 as soon as initialization is completed.

In the unarmed state 132, the base 22 carries out the beacon discovery process by sending out Bluetooth scan packets and awaiting responses. This may occur, for example, every 100 milliseconds. When responses are received, connections are established with the responding beacons 18. The system remain in the unarmed state until one or more beacon connections are established and the user arms the system by activating the alarm activation circuit 32 to the armed position. The unarmed state 132 may only transition to the armed state 134.

In the armed state 134, the base 22 actively monitors all existing beacon connections for alarm conditions. In the event of excessive signal degradation or lost signal, the state would transition to the alarm state 136. A transition back to the unarmed state is also possible if the user manually disarms by deactivating the alarm activation circuit 32. The alarm state 136 is entered once the base 22 has detected an alarm condition. In this state, the base 22 activates visual alarm indicators on the display 42 and an audible alarm indicator using the horn 38. The alarm state 136 may only transition back to the unarmed state 132 via manual user operation using the alarm activation circuit 32.

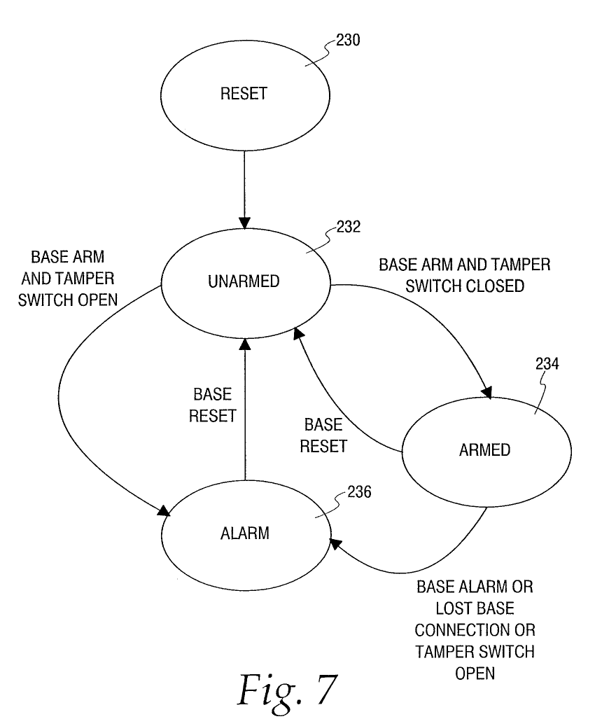

FIG. 7 illustrates the state diagram for the beacons 18. Similar to the base 22, these states comprise a reset state 230, an unarmed state 232, an armed state 234 and an alarm state 236.

The reset state 230 is identical to the reset state 130 in the base 22. The reset state 230 transitions automatically to the unarmed state 232 after device initialization is complete. In the unarmed state 232, the beacon 18 responds to the base scan requests, establishes a base connection, and awaits a signal from the base 22 to transition to the armed state 234. If an arm request is received from the base 22 and the tamper switch 68 is open, the beacon 18 will transition to the alarm state 236. If the tamper switch 68 is closed, then the beacon 18 transitions to the armed state 234.

In the armed state 234, the beacon 18 responds to the base poll requests and monitors the tamper switch 68. If a reset request is received in the base 22, then the beacon 18 will transition back to the unarmed state 232. Otherwise, if an alarm signal is received from the base 22, or the Bluetooth connection to the base 22 is lost, or the tamper switch 68 opens, then the state transitions to the alarm state 236.

The alarm state 236 is entered if the beacon 18 receives an alarm signal from the base 22, or its Bluetooth connection is lost, or the tamper switch 68 opens, as noted. In the alarm state 236, the beacon 18 activates both visual alarms using indicators 78 and 80 and an audible alarm using the horn 76. The alarm state 236 may only transition back to the unarmed state 232 in response to a signal from the base 22.

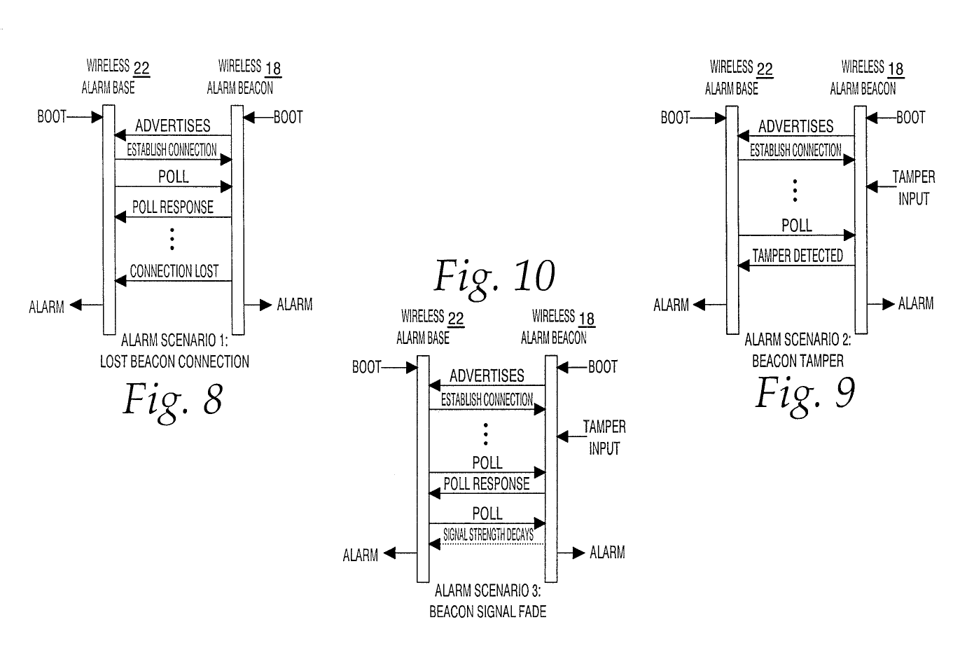

There are three scenarios under which the base 22 may transition to the alarm state. FIGS. 8, 9 and 10 are event diagrams corresponding to the three scenarios.

FIG. 8 illustrates a first alarm scenario where there is a lost beacon connection. All of the scenarios begin with the boot sequence followed by the beacon 18 advertising its user ID and establishing connection with the base 22. Thereafter, during main loop operation, the alarm base 22 periodically polls the beacon 18 which responds with a poll response. If, however, the polling signal is not received by the beacon 18 or the poll response is not received by the base 22, then the connection is lost and an alert signal is generated in both devices which then generate an alarm.

The second alarm scenario in FIG. 9 is a beacon tamper scenario. In this scenario, one or more beacons 18 have detected an open condition on its tamper switch 68. In this case, the beacon 18 will transition to alarm state and after polling, signal the base 22 that it has done so after which the base 22 will also transition to the alarm state.

The third scenario in FIG. 10 is based on the beacon signal fading due to a low RSSI detected by the base 22. While in the arm state 134, the base 22 monitors the RSSI provided by the BLE stack for each established beacon connection. If it is determined due to signal strength decay and by statistical analysis of the RSSI that one or more beacons 18 have moved out of range of the base 22, the base 22 will transition to the alarm state 136 and signal the out of range beacon 18 that it has done so. The out of range beacon 18 will then in turn transition to the alarm state.

Thus, as described, the wireless security system 10 comprises the base 22 including a Bluetooth Smart module 24 comprising a programmed controller and a base Bluetooth wireless communication circuit. Each wireless sensor 14 comprises a housing 16 enclosing a Bluetooth Smart module 50 comprising an integrated programmed controller and sensor Bluetooth wireless communication circuit. The sensor module 50 communicates with the base module 24. A tamper circuit 68 is associated with a push button 72 or tether 74, or the like, to maintain the housing 16 in an operative state on a portable article being monitored. The sensor module 50 generates an alert signal in the event that the securing assembly is altered with the housing 16 in an operative state in a manner that allows separation of the housing 16 from the portable article being monitored. The base 22 is programmed to activate a base alarm indicator circuit 42 if at least one wireless sensor 14 generates an alert signal or if the base 22 senses a communication error with one of the wireless sensors 14. The communication error can be a lost connection or reduced signal strength.

The foregoing disclosure of specific embodiments is intended to be illustrative of the broad concepts comprehended by the invention.

1. A wireless security system for monitoring portable articles comprising:
a base unit comprising a programmed controller operatively associated with a base wireless communication circuit and a base alarm indicator circuit; and
at least one wireless sensor comprising a housing enclosing a programmed controller operatively associated with a sensor wireless communication circuit, for communicating with the base wireless communication circuit, and a securing assembly configured to: maintain the housing in an operative state on a portable article being monitored; and
generate an alert signal in the event that the securing assembly is altered with the housing in the operative state in a manner that allows separation of the housing from a portable article being monitored,
wherein the base unit is programmed to activate the base alarm indicator circuit if the at least one wireless sensor generates an alert signal or if the base unit senses a communication error with the at least one wireless sensor.

2. The wireless security system according to claim 1 wherein the securing assembly comprises a tether that in conjunction with the housing extends fully around a part of a portable article being monitored with the housing in its operative state.

3. The wireless security system according to claim 1 wherein the securing assembly comprises a tether that extends fully around a part of an article being monitored with the housing in its operative state.

4. The wireless security system according to claim 1 wherein the securing assembly comprises a tether that defines at least a part of an electrical circuit path, and the securing assembly is configured to generate the alert signal in the event that the electrical circuit path is interrupted.

5. The wireless security system according to claim 1 wherein the base unit senses a communication error in the event that the housing is moved outside of a predetermined area.

6. The wireless security system according to claim 1 wherein the base unit senses a communication error in the event that communication is lost with the at least one wireless sensor.

7. The wireless security system according to claim 1 wherein the at least one wireless sensor comprises a sensor alarm indicator circuit and the at least one wireless sensor is programmed to activate the sensor alarm indicator circuit if the at least one wireless sensor generates an alert signal or if the base unit senses a communication error with the at least one wireless sensor.

8. The wireless security system according to claim 1 wherein the base unit comprises a Bluetooth Smart module comprising the programmed controller and the base wireless communication circuit.

9. The wireless security system according to claim 1 wherein the wireless sensor comprises a Bluetooth Smart module comprising the programmed controller and the sensor wireless communication circuit.

10. The wireless security system according to claim 1 wherein the base wireless communication circuit periodically polls the sensor wireless communication circuit and the sensor's wireless communication circuit responds with data representing an identification parameter and status of the alert signal.

11. The wireless security system according to claim 1 wherein each of the base unit and the at least one wireless sensor comprises a calibrate button used to link the base wireless communication circuit with the sensor wireless communication circuit.

12. A wireless security system for monitoring portable articles comprising:
a base unit comprising a programmed controller operatively associated with a base wireless communication circuit and a base alarm indicator circuit; and
a plurality of wireless sensors, each comprising a housing enclosing a programmed controller operatively associated with a sensor wireless communication circuit, for communicating with the base wireless communication circuit, and a securing assembly configured to: maintain the housing in an operative state on a portable article being monitored; and
generate an alert signal in the event that the securing assembly is altered with the housing in the operative state in a manner that allows separation of the housing from a portable article being monitored,
wherein the base unit is programmed to activate the base alarm indicator circuit if any of the plurality of wireless sensors generates an alert signal or if the base unit senses a communication error with any of the plurality of wireless sensors.

13. The wireless security system according to claim 12 wherein the securing assembly comprises a tether that in conjunction with the housing extends fully around a part of a portable article being monitored with the housing in its operative state.

14. The wireless security system according to claim 12 wherein the securing assembly comprises a tether that extends fully around a part of an article being monitored with the housing in its operative state.

15. The wireless security system according to claim 12 wherein the securing assembly comprises a tether that defines at least a part of an electrical circuit path, and the securing assembly is configured to generate the alert signal in the event that the electrical circuit path is interrupted.

16. The wireless security system according to claim 12 wherein the base unit senses a communication error in the event that any of the plurality of wireless sensors is moved outside of a predetermined area.

17. The wireless security system according to claim 12 wherein the base unit senses a communication error in the event that communication is lost with the any of the plurality of wireless sensors.

18. The wireless security system according to claim 12 wherein each wireless sensor comprises a sensor alarm indicator circuit and each wireless sensor is programmed to activate the sensor alarm indicator circuit if the wireless sensor generates an alert signal or if the base unit senses a communication error with the wireless sensor.

19. The wireless security system according to claim 12 wherein the base unit comprises a Bluetooth Smart module comprising the programmed controller and the base wireless communication circuit.

20. The wireless security system according to claim 12 wherein each wireless sensor comprises a Bluetooth Smart module comprising the programmed controller and the sensor wireless communication circuit.

21. The wireless security system according to claim 12 wherein the base wireless communication circuit periodically polls the sensor wireless communication circuits and each sensor's wireless communication circuit responds with data representing an identification parameter and status of the alert signal.

22. The wireless security system according to claim 12 wherein each of the base unit and the wireless sensors comprises a calibrate button used to link the base wireless communication circuit with the sensor wireless communication circuits.
